(19) United States
(12) Patent Application Publication
(10) Pub. No.: US 2023/0287998 A1
(43) Pub. Date: Sep. 14, 2023

(54) SYSTEM AND METHOD FOR VISUALLY INDICATING WHETHER PIPE JOINTS HAVE BEEN PROPERLY CRIMPED

(71) Applicant: MERIT BRASS CO., CLEVELAND, OH (US)

(72) Inventors: Tyson Higginbotham, Lake Wylie, SC (US); John Higdon, CLEVELAND, OH (US); Brian Ragone, CLEVELAND, OH (US)

(21) Appl. No.: 18/198,550

(22) Filed: May 17, 2023

Related U.S. Application Data
(63) Continuation-in-part of application No. 17/318,080, filed on May 12, 2021.
(60) Provisional application No. 63/035,038, filed on Jun. 5, 2020.

(51) Int. Cl. F16L 13/14

(52) U.S. Cl. CPC F16L 13/142; F16L 2201/10

(57) ABSTRACT

The present invention relates to a female press fitting that is provided with a visual indicator that indicates whether the female press fitting has been properly crimped onto a male pipe or fitting.

### CROSS-REFERENCE TO RELATED APPLICATION

This application is a continuation-in-part of the U.S. patent application Ser. No. 17/318,080, filed on May 12, 2021, entitled “System and Method for Visually Indicating Whether Pipe Joints Have Been Properly Crimped,” which claims priority to U.S. Provisional Patent Application 63/035,038, filed on Jun. 5, 2020, entitled “CopperPress® System and Method for Visually Indicating Whether Pipe Joints Have Been Properly Crimped or Pressed,” which are all incorporated herein by reference in their entirety.

### FIELD OF THE INVENTION

The present invention relates to pipe couplings and more particularly to a system and process for visually indicating whether pipe couplings comprising male and female fittings have been properly crimped.

### BACKGROUND OF THE INVENTION

Copper press fittings have long been used to quickly and easily form leak tight joints between male and female pipe connections. Typically, these copper press fittings are integrated into a pipe network that includes an array of pipe and fittings secured together. Typically, the female press fitting includes a raised bead that is disposed adjacent to one end of the female fitting. Contained in the female press fitting is a sealing element that typically lies in an internal groove formed by the raised bead. A joint is created by extending a male pipe or fitting into the female press fitting a selected distance. To form a leak tight seal between the two, a crimping tool engages the bead and crimps the same, causing the internal sealing element to seal the interface between the male pipe or fitting and the female press fitting. More particularly, when the crimping tool crimps the bead of the female press fitting, this imparts a mechanical force against the bead which results in the female press fitting being deformed and causing the internal sealing element to impinge on the outer diameter of the male pipe or fitting, thereby creating a permanent leak tight seal.

There are a number of advantages to this approach of connecting female press fittings to male pipe or fittings. One advantage of a pressed fitting over conventional joining methods is speed of installation which can be accomplished without flux, filler material, sealing compounds or open flames. Besides that, such a system and process is safe and presents a neat and clean appearance to the joint.

In pipe networks, there can be hundreds of joints created by male and female press fittings. In some cases, numerous workers are involved in installing the pipe network. Sometimes pipe joints are not crimped or are improperly crimped, resulting in a problem. Additionally, the correct sealing element depends on a given application. Eventually the pipe network will be pressurized and where joints have not been crimped, have been improperly crimped, or the incorrect sealing element was used, leaks can occur and in some cases the pipe fittings can break apart, creating environmental, economic and safety hazards in and around the pipe network.

Therefore, there is a need for a system and process that will enable plumbers and other workers to easily determine if pressed fitting joints in a pipe network have been properly crimped and whether the correct sealing element was used, even in light challenged environments.

### SUMMARY OF THE INVENTION

The present invention entails a method of preparing a female press fitting with a visual indicator or visual indicator press ring (VIPR) that indicates whether the female press fitting has been crimped around a male pipe or fitting to form a leak tight seal.

Provided is a female press fitting designed to receive a male pipe or fitting. The female press fitting comprises a pipe section comprising at least two ends. The female press fitting also comprises at least one raised bead forming an internal groove in the pipe section adjacent to one or more ends. The female press fitting also comprises a sealing element disposed in the internal groove underneath the at least one raised bead. The female press fitting also comprises a heat shrunk plastic ring extending over and around the at least one raised bead and held on the pipe section, wherein the heat shrunk plastic ring is color coded based on characteristics of the sealing element, wherein the heat shrunk plastic ring is designed to break and separate from the pipe section in response to a crimping force being applied to the heat shrunk plastic ring and the at least one raised bead, and wherein a presence of the heat shrunk plastic ring on the female press fitting that has received the male pipe or fitting indicates that the female press fitting has not been crimped or has been improperly crimped.

The heat shrunk plastic ring may be color coded with one or more photoluminescence colors or one or more colors that are not photoluminescence.

The one or more photoluminescence colors or the one or more colors may form different patterns, designs, words, or logos that can be useful in determining if the two applicable pipes are properly sealed together.

The characteristics of the sealing element may comprise type of sealing element, pressure suitability, or temperature suitability.

The type of sealing element may comprise ethylene-propylene-diene monomer (EPDM), hydrogenated nitrile butadiene rubber (HNBR), fluoroelastomer (FKM), Teflon®, or Neoprene®.

The heat shrunk plastic ring may be embedded with mechanophores to indicate distribution and magnitude of pressure applied on the at least one raised bead by changing color during the engagement of the two applicable pipe ends.

The heat shrunk plastic ring may be embedded with a radio frequency identification (RFID) tag, wherein the RFID tag may store information comprising a website link for installation instructions, suitability for service, limitations of use, type of sealing element, pressure suitability, or temperature suitability. The information may also include warranty information, information on the pipes and the fittings, force required to properly crimp the pipes, operating limitations, and any other relevant information regarding the pipes.

A website link or Quick Response (QR) code containing the website link may be printed on the heat shrunk plastic ring, and wherein the website link contains installation instructions, operating instructions, functional limitations, warranty information, manufacturer information, force required to properly crimp the pipes, operating limitations, and any other relevant information regarding the pipes or the like.

The sealing element may be driven inwardly into a sealing contact and engage with the male pipe or fitting in response to the crimping force being applied to the heat shrunk plastic ring.

The heat shrunk plastic ring may be designed to break in a predefined location and separate from the pipe section in response to the crimping force at the predefined location. By way of non-limiting example, the heat shrunk plastic ring may comprise one or more perforated lines designed to break at the one or more perforated lines and separate from the pipe section in response to the crimping force.

The heat shrunk plastic ring may vary in thickness and break at a relatively thin area.

The heat shrunk plastic ring may comprise a uniform thickness at a sufficiently low yield strength designed to break in response to the crimping force.

The heat shrunk plastic ring may comprise strips held together with an adhesive and be designed to break into the strips.

The heat shrunk plastic ring may be designed to break at about 20% of the crimping force of approximately 7200 pounds.

Provided is another female press fitting designed to receive a male pipe or fitting. The female press fitting comprises a pipe section comprising at least two ends, one or more raised beads forming one or more internal grooves in the pipe section adjacent to the at least two ends, a sealing element disposed in the one or more internal grooves underneath the one or more raised beads, and a paper material ring extending over and around the one or more raised beads and held on the pipe section, wherein the paper material ring is designed to break in response to a crimping force being applied to the paper material ring.

Provided is another female press fitting that comprises a pipe section, one or more raised beads forming one or more grooves in the pipe section, one or more metallic foil rings extending over and around the one or more raised beads and held on the pipe section, and a sealing element disposed in the one or more grooves. The sealing element may form a sealing contact with a male pipe in response to a crimping force applied to the one more raised bead. The one or more metallic foil rings may be designed to break in response to a crimping force being applied to the one or more metallic foil rings to indicate that the female press fitting has been properly crimped and/or to alert the user that it has not been properly crimped.

Other objects and advantages of the present invention will become apparent and obvious from a study of the following description and the accompanying drawings which are merely illustrative of such invention.

### BRIEF DESCRIPTION OF THE DRAWINGS

FIG. 1A is a perspective view showing a male pipe inserted into opposite ends of a female press fitting.

FIG. 1B is a perspective view of the assembly shown in FIG. 1A but showing a crimping tool engaging one of the heat shrunk visual indicators formed on the female press fitting.

FIG. 1C is a view similar to FIG. 1B but showing the heat shrunk plastic band broken or ruptured into one piece following crimping.

FIG. 1D is a perspective view of the female press fitting coupled to opposed male pipe after crimping.

FIG. 2 is a cross-sectional view taken along the lines II-II of FIG. 1C.

FIG. 3A is a perspective view of the heat shrunk plastic band with an embedded radio frequency identification (RFID) tag.

FIG. 3B is a perspective view of the heat shrunk plastic band with an Electronic Product Code (EPC) label.

FIG. 4A is a perspective view of the heat shrunk plastic band with a website link.

FIG. 4B is a perspective view of the heat shrunk plastic band with a Quick Response (QR) code.

FIG. 5A is a perspective view of the heat shrunk plastic band with a logo.

FIG. 5B is a perspective view of the heat shrunk plastic band with a brand of sealing element.

FIG. 6 is a perspective view of the heat shrunk plastic band with perforated lines.

FIG. 7A is a perspective view of a plastic ring formed on the female press fitting.

FIG. 7B is a perspective view of a metallic foil ring formed on the female press fitting.

FIG. 7C is a perspective view of a paper material ring formed on the female press fitting.

FIG. 8A-8F are perspective views of the heat shrunk plastic band with different design and color patterns.

FIG. 9 is a perspective view of the heat shrunk plastic band with embedded mechanophores.

### DESCRIPTION OF EXEMPLARY EMBODIMENT

With further reference to the drawings, the present invention describes a female press fitting that includes a visual indicator or visual indicator press ring (VIPR) that is designed to indicate whether the female press fitting has been crimped or has been properly crimped. As discussed below, the female press fitting includes a heat shrunk color coded plastic ring that extends around the raised bead of the female press fitting. The heat shrunk plastic ring is color coded based on the type of sealing elements used. By way of a non-limiting example, ethylene-propylene-diene monomer (EPDM) sealing elements can be color coded green and hydrogenated nitrile butadiene rubber (HNBR) sealing elements can be color coded yellow. The opposite could also be utilized and alternative colors can be used without departing from the present teachings. The heat shrunk plastic ring can be made of reflective or photoluminescence material, making visual identification even in light challenged environments less difficult. In some embodiments, the heat shrunk plastic ring can be made of material that is sensitive to a black light so that a black light may be utilized, especially in dim light conditions, and the heat shrunk plastic ring can be configured to glow from the black light. Additionally, the heat shrunk plastic ring can include a radio frequency identification (RFID) tag, allowing product information to be scanned and stored prior to, during or after installation.

This heat shrunk plastic ring may be designed to rupture and fall from the female pipe fitting in response to a proper crimping action being applied to the heat shrunk plastic ring and raised bead. Hence, when a pipe network comprising an array of pipe and male and female press fittings is inspected, an inspector can readily determine if the various pipe joints formed in the pipe network have been properly crimped and the correct sealing element was used, even in light challenged environments.

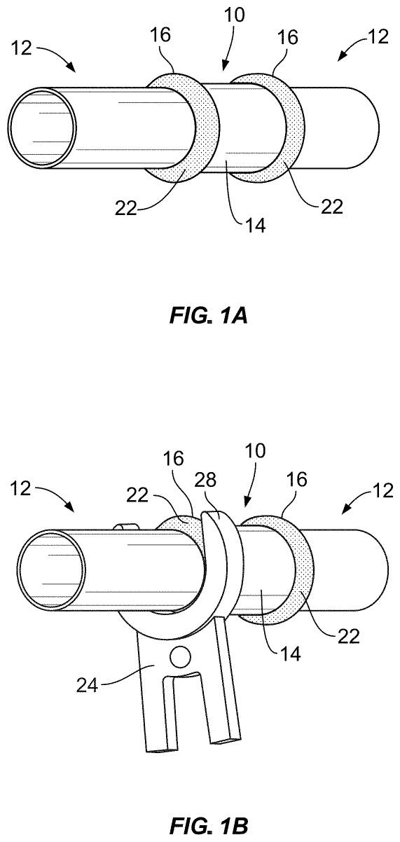

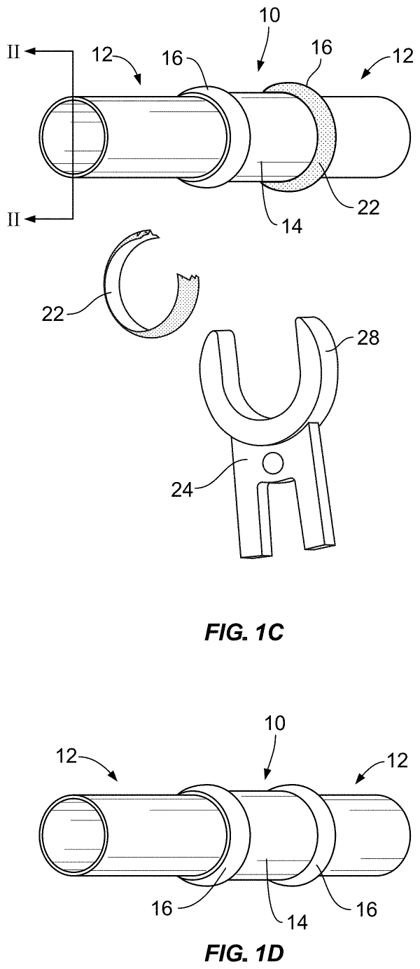

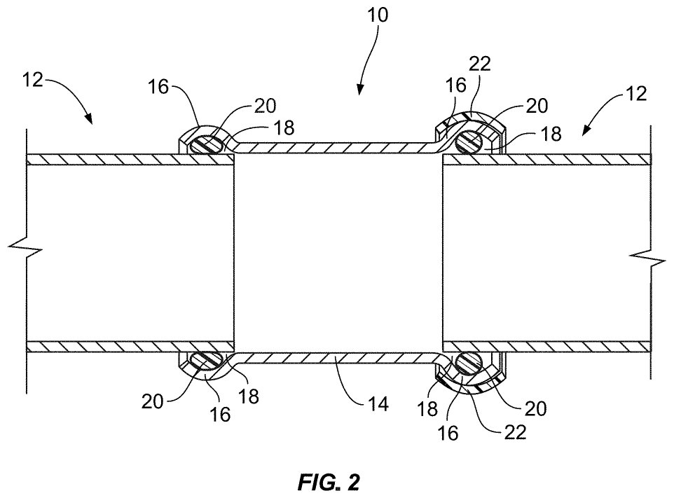

Now with particular reference to the drawings, particularly FIG. 1, there is shown therein a female press fitting indicated generally by the numeral 10. The female press fitting 10 is designed to receive a male pipe or fitting 12. In the particular embodiment or design shown in FIG. 1A, the female press fitting 10 includes opposed ends and there is a male pipe or fitting 12 inserted into each end thereof. As discussed below, in forming a joint between a female press fitting 10 and a male pipe or fitting 12, the male pipe or fitting 12 is inserted into the female press fitting 10 and thereafter the interface is sealed through a crimping procedure that causes an internal seal 20 to impinge and engage a portion of the underlying male pipe or fitting 12. See FIG. 2.

Female press fitting 10 comprises in one design or embodiment a pipe section 14. Pipe section 14 includes opposed ends. Pipe section 14 is provided with one or two raised beads 16. In the embodiment illustrated herein, pipe section 14 is provided with a pair of axially spaced raised beads 16 with each raised bead 16 being disposed adjacent to one end portion of the pipe section 14. See FIG. 1D.

The raised bead 16 forms an internal groove 18 that extends around the underside of the raised bead 16. See FIG. 2. Seated in the groove 18 is a sealing element 20, such as an O-ring or any type of sealing elements suitable for a given application or purpose. For example, three of the most common sealing elements are ethylene-propylene-diene monomer (EPDM) which is suitable to any type of water application, hydrogenated nitrile butadiene rubber (HNBR) which is suitable for gas applications, and fluoroelastomer (FKM) which is suitable for industrial applications with harsh, corrosive conditions. Other examples of sealing elements include, but not limited to, Teflon® which is suitable for chemical processing and Neoprene® which is suitable for refrigerant systems.

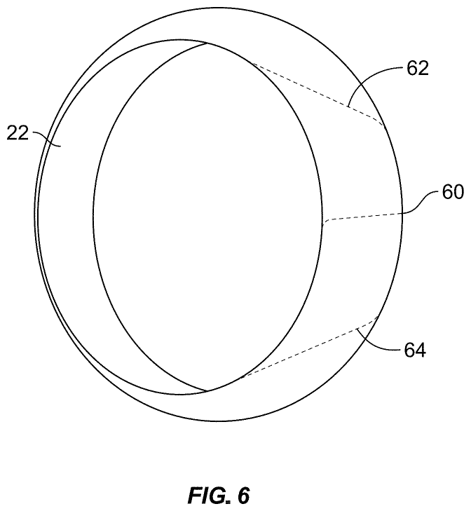

Formed on the raised bead 16 is a heat shrunk plastic ring 22, which is a visual indicator or VIPR formed on the female press fitting 10 to indicate the type of sealing element 20 seated in the groove 18. In the manufacturing process, the heat shrunk plastic ring 22 is inserted over and around the raised bead 16. The heat shrunk plastic ring 22 can be provided with a perforation line that will enable the heat shrunk plastic ring 22 to rupture and separate from the female press fitting 10. There are various processes that can be used to assure that the heat shrunk plastic ring 22, once heat shrunk around the raised bead 16, will rupture or break in response to a crimping action. As noted above, one approach is to provide a perforated line extending transversely across the heat shrunk plastic ring 22 in one area to break at one location or more than one area to break at multiple locations. See FIG. 6, which illustrates example-perforated lines 60, 62, and 64. It is contemplated that the heat shrunk plastic ring 22 may have one or more perforated lines extending transversely across the heat shrunk plastic ring 22 in a perpendicular direction such as the perforated line 60, in a first diagonal direction such as the perforated line 62, or in a second (opposed) diagonal direction such as the perforated line 64. One perforated line can result in a clean break so that the heat shrunk plastic ring 22 remains in one piece, however, two or more perforated lines can ensure that the heat shrunk plastic ring 22 breaks when it is crimped at each of the perforated lines. Having two such perforation lines may help ensure that the heat shrunk plastic ring 22 will actually break upon application of the crimping force. Moreover, any number of perforated lines may be utilized such that the heat shrunk plastic ring 22 may break at a number of perforated lines upon the crimping force being applied.

Another possible approach is to utilize a heat shrunk plastic ring having a varying thickness with one relatively thin area of the heat shrunk plastic ring being particularly designed to rupture or break in response to a crimping action being applied to the heat shrunk plastic ring. Alternately, the heat shrunk plastic ring 22 may be designed with a uniform thickness and a yield strength sufficiently low such that the heat shrunk plastic ring 22 tears away from the raised bead 16 during the crimping action. In another example, the plastic material is produced in strips which are folded over on themselves and held together with an adhesive, and the plastic material is designed to break away into strips (e.g., along a folded line). The resulting heat shrunk plastic ring 22 will typically fail (break away) where it is joined together. A typical crimping tool exerts a force of approximately 7200 pounds onto the raised bead 16. The heat shrunk plastic ring 22 disclosed herein is designed to rupture or break at about 20% of the crimping force. This ensures that the heat shrunk plastic ring 22 will always break and fall away.

The basic idea underlying the present invention is to provide a visual indicator or VIPR that will indicate to an inspector or other workers that the female press fitting 10 has been properly crimped onto the male pipe or fitting 12 and the correct sealing element 20 is used, even in light challenged environments. That is, during the inspection process, if a female press fitting 10 includes the heat shrunk plastic ring 22 extending around the raised bead 16, then it is apparent that the female press fitting 10 has not been crimped or properly crimped. On the other hand, if after installation the inspection reveals that there are no heat shrunk plastic rings 22 on any of the female press fittings 10, then it follows that they have all been appropriately crimped which in turn creates a leak tight seal at the interface between the male pipe or fittings 12 and the female press fittings 10.

As noted above, the heat shrunk plastic ring 22 may be incorporated into the female press fitting 10 during the manufacturing process. When the female press fittings 10 reach a job site, they are typically used in a pipe network that includes a series of male pipe or fittings 12 and a series of female press fittings 10.

In the course of forming a pipe network, the male pipe or fittings 12 are inserted into one end of the female press fittings 10. See FIG. 2. The male pipe or fitting 12 is inserted to where at least the sealing element 20 in the female press fitting 10 overlies a portion of the male pipe or fitting 12. At this point, a crimping tool 24 is used. The crimping tool 24 is placed around the heat shrunk plastic ring 22 and a crimping force is applied to the heat shrunk plastic ring 22 as well as the underlying raised bead 16. See FIG. 1B. This crimping action causes the internal sealing element 20 to be driven inwardly into a sealing contact with the underlying male pipe or fitting 12. This creates a leak tight seal. See FIG. 2 where only the leftmost raised bead 16 has been crimped, causing the sealing element 20 to form a leak tight joint between the female press fitting 10 and the male pipe or fitting 12. The crimping action of the crimping tool 24 causes the heat shrunk plastic ring 22 to rupture or break. It is designed to rupture or break in response to a crimping force being applied. When the heat shrunk plastic ring 22 ruptures or breaks, in a preferred embodiment, it breaks in one place or along a perforated line and falls away from the female press fitting 10. See FIG. 1C. Once the heat shrunk plastic ring 22 has ruptured and falls from the female press fitting 10, this is an indication that the joint created between the female press fitting 10 and the male pipe or fitting 12 is leak tight.

The basic concepts underlying the present invention come from the necessity of having means to quickly and easily determine if a small diameter (½″-2″) copper press fitting has been pressed prior to pressurizing a network of pipes and contain the correct sealing element 20 for a given application, even in light challenged environments. The heat shrunk plastic ring 22 can be color coded with one or more colors based on the characteristics of the sealing element 20, wherein the one or more colors can be any color. For example, the heat shrunk plastic ring 22 can be color coded based on the type of sealing elements, which allows for a quick visual determination of the sealing element 20 inside of the female press fitting 10 to assure that the sealing element 20 is correct for a given application or purpose. By way of a non-limiting example, a green heat shrunk plastic ring 22 can indicate suitability for an aqueous application and a yellow heat shrunk plastic ring 22 can indicate suitability for a gas application.

The heat shrunk plastic ring 22 can also be made of reflective or photoluminescence material, making visual identification even in light challenged environments less difficult. Photoluminescence material absorbs natural and artificial light as photons and then re-emits the trapped energy as lower wavelength light in the darkness. The heat shrunk plastic ring 22 can also be color coded with one or more photoluminescence pigments or colors based on characteristics of the sealing element 20. For example, the heat shrunk plastic ring 22 can be photoluminescence color coded with any photoluminescence colors such as, but not limited to, blue, green, yellow, red, orange, pink, and the like. The heat shrunk plastic ring 22 can also include a pattern that comprises a photoluminescence material that can make identification in the dark easier. This could assist the user with identifying where the heat shrunk plastic ring 22 is and where the crimping tool is to be applied. It also will show in a low light environment if the heat shrunk plastic ring 22 has ruptured or broken and fallen away from the female press fitting 10. The photoluminescence material on the broken away heat shrunk plastic ring 22 can be visible to the user to show that it has in fact broken away and that the seal is complete.

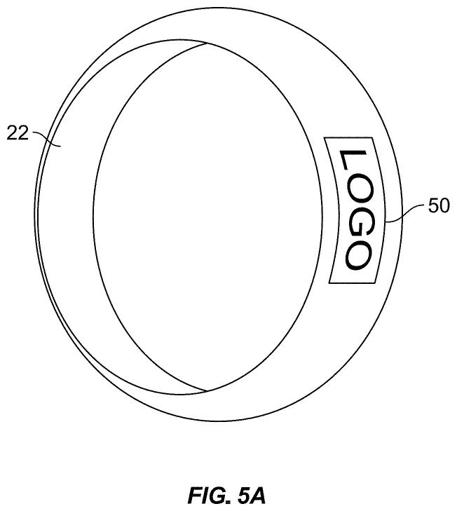

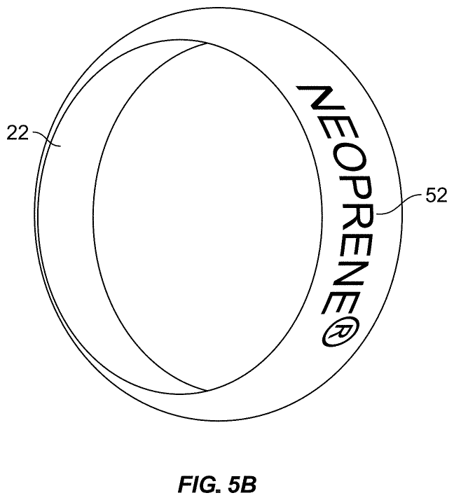

It is contemplated that the heat shrunk plastic ring 22 can be color coded with one or more colors (e.g., colors that are not photoluminescence) and one or more photoluminescence colors to form different patterns between the colored portion and the photoluminescence colored portion. For example, the colored and photoluminescence colored portions can form a stripe pattern, another pattern or design, words or logos visualizing other characteristics of the sealing element 20 or female press fitting 10, or the like. For example, FIG. 5A illustrates the heat shrunk plastic ring 22 including logo 50 to indicate the type of sealing element 20, however, the logo 50 may be used to indicate other information. By way of a non-limiting example, the logo 50 can be used to indicate information regarding the manufacturer, brand, pressure and temperature limitations, size of the female press fitting 10, press tool (e.g., crimping tool) information, date of manufacture of the female press fitting 10 or sealing element 20, or sealing element material. In addition, the logo 50 can provide instructions to the user as to the amount of crimping force required for a specific application. The logo 50 can provide any relevant information regarding the process of engaging the pipes and crimping the ends into engagement thereof.

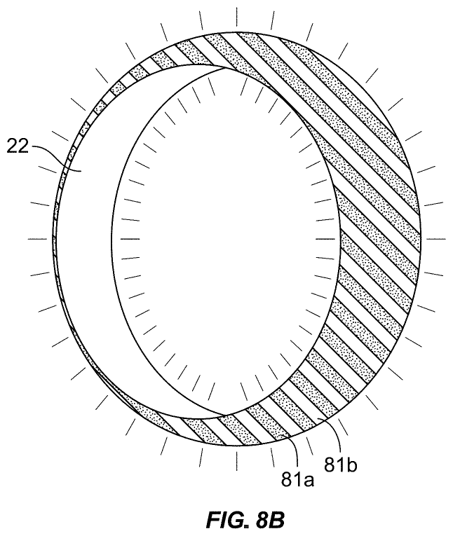

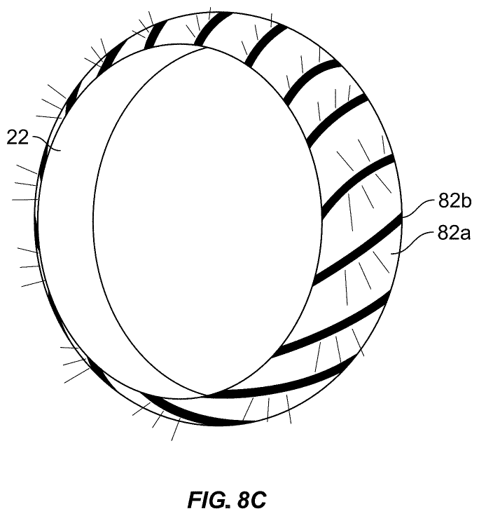

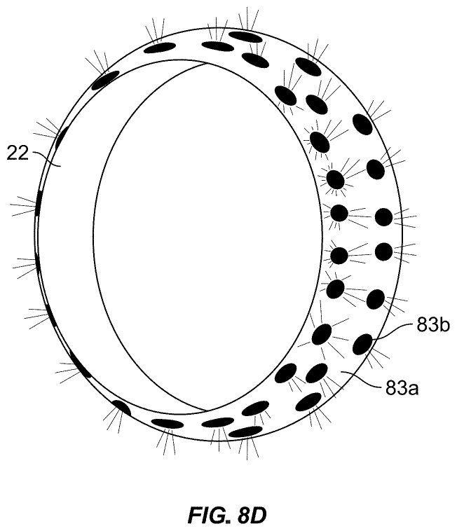

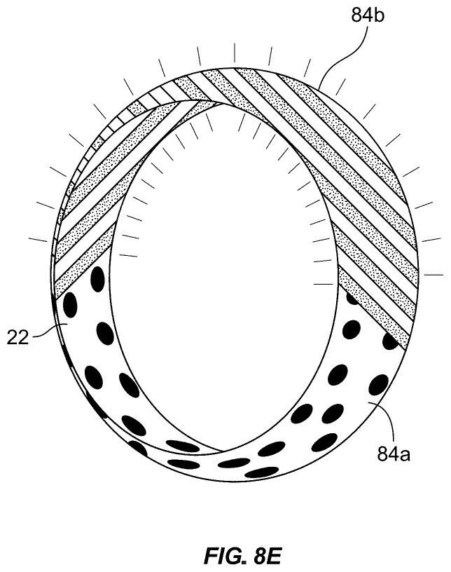

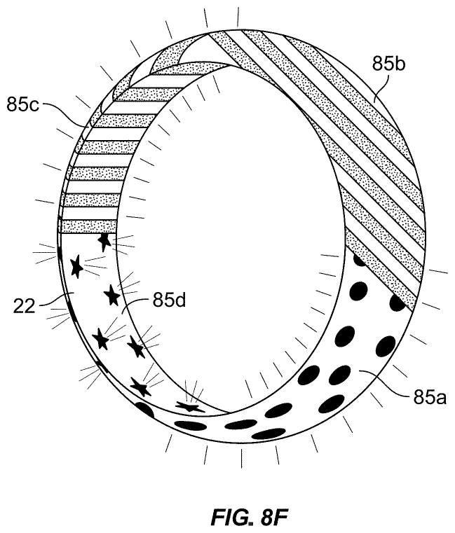

As another example, FIG. 5B illustrates heat shrunk plastic ring 22 including the brand of the sealing element 20 such as Neoprene® 52. The colored portion can signify a one or more characteristics of the sealing element 20 while the photoluminescence colored portion can signify a different set of one or more characteristics of the sealing element 20. For example, FIGS. 8A-8F illustrates the heat shrunk plastic ring 22 having different designs and different colors to indicate different characteristic of the sealing element 20. FIG. 8A illustrates the heat shrunk plastic ring 22 includes stripes 80a and 80b with each indicating a different characteristic of the sealing element 20. The stripes 80a and 80b can indicate application suitability (e.g., aqueous or gas applications and the like), temperature suitability, pressure suitability, etc. The patterns can also be used to indicate these characteristics or application suitability. For example, stripe patterns can be used to indicate suitability for gas applications and solid color patterns can be used to indicate aqueous application. This way a user will know that the pipes being used are the correct ones for the specific application.

Stripe patterns can also be used to aid in the visibility of the heat shrunk plastic ring 22 providing an additional contrast to the fitting body (e.g., female press fitting 10). As shown in FIG. 8B, the stripes 81a and 81b can be photoluminescence colored stripes. The stripes 81a and 81b can provide a highly visible contrast to the fitting body, and photoluminescence adds to this effect and can also glow in different colors. For example, green can indicate an EPDM seal and yellow can indicate an HNBR seal. As shown in FIG. 8C, the stripes can be a combination of colored stripes and photoluminescence colored stripes such as colored stripes 82a and photoluminescence colored stripes 82b. This can help ensure that the appropriate pipe is used for the specific application for which it is intended.

The heat shrunk plastic ring 22 can have other designs and color combinations such as, but not limited to, photoluminescence dots 83b in contrast to colored portion 83a of the heat shrunk plastic ring 22. The heat shrunk plastic ring 22 can also have one or more designs such as half of the heat shrunk plastic ring 22 can have a dots design 84a and the other half can have a stripes design 84b as shown in FIG. 8E. The designs 84a and 84ab can be used to indicate any of the aforementioned characteristics of the fitting (e.g., female press fitting 10) or its suitability for a given application. For example, the designs 84a and 84b can be used to indicate application suitability (e.g., aqueous or gas applications and the like), temperature suitability, pressure suitability, etc. The contrasting designs 84a and 84b can also make the heat shrunk plastic ring 22 highly visible.

In another example, the heat shrunk plastic ring 22 can have four designs such as each quarter of the heat shrunk plastic ring 22 can have designs 85a, 85b, 85c, and 85d as shown in FIG. 8F. These designs and color combinations are for illustration purposes and not meant to be restrictive, however, it is contemplated that a design with few patterns and color combination may be more practical as the heat shrunk plastic ring 22 can be small in dimension. For example, the heat shrunk plastic ring 22 can have a different color for each type of sealing element 20 and the different colors can be photoluminescence for visibility. This is an advantage as the sealing elements 20 used are nearly identical in appearance and are otherwise difficult to differentiate.

In addition, pressure (e.g., pressure of a pressurized pipe) and temperature indicating materials can also be utilized. Just as the heat shrunk plastic ring 22 can be color-coded or photoluminescence color-coded to indicate the type of sealing element 20, it can also be color-coded or photoluminescence color-coded to indicate pressure or temperature suitability of the sealing element 20. The color and design patterns illustrated in FIGS. 8A-8F can also be used for this purpose. The heat shrunk plastic rings 22 can be color-coded or photoluminescence color coded to indicate different characteristics of the sealing element 20 such as, but not limited to, the type of sealing element, pressure suitability, temperature suitability, and the like. By way of a non-limiting example, a green color or a green photoluminescence color can be used to indicate an EPDM seal suitable for an aqueous application and a yellow color or a yellow photoluminescence color can be used to indicate an HNBR seal suitable for gas applications. This will help ensure that the appropriate pipe is used for the specific application. As another example, other colors or photoluminescence colors can be used to indicate temperature suitability such as blue for cold temperature applications and orange for high temperature application.

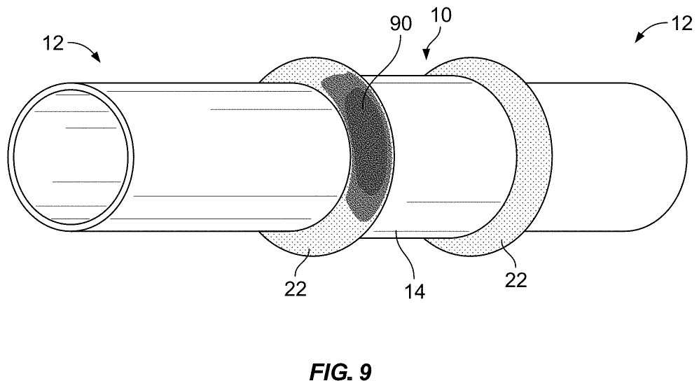

The pressure and temperature suitability ranges can also be printed on the heat shrunk plastic rings 22. Beyond the pressure and temperature suitability, the heat shrunk plastic rings 22 can also show the distribution and magnitude of pressure applied between jaw 28 of the crimping tool 24 and the raised bead 16. See FIGS. 1B and 1C. The heat shrunk plastic ring 22 can be embedded with mechanophores to indicate the distribution and magnitude of pressure applied by changing color, if the amount of pressure applied is adequate. See FIG. 9 wherein embedded mechanophore 90 indicates pressure was applied to the heat shrunk plastic ring 22. Based on the amount of pressure applied, the mechanophore 90 can indicate the same by changing to different colors. This can be used to quickly tell, for instance, if the crimping tool 24 is low on its battery life and is not exerting enough force to make a quality press. For example, the mechanophores 90 can be specified to require a minimum mechanical force to change colors or fluoresce. So if a press (or crimp) was made and no color change was observed, it could be deduced that the battery on the press tool (e.g., crimping tool 24) was weak and in need of recharging, and that perhaps the press force was inadequate to deliver a leak tight seal. The same can be true if the press tool is manual, i.e., if there is no color change observed, the user did not apply enough force or more specifically the predetermined force to create the proper or effective seal.

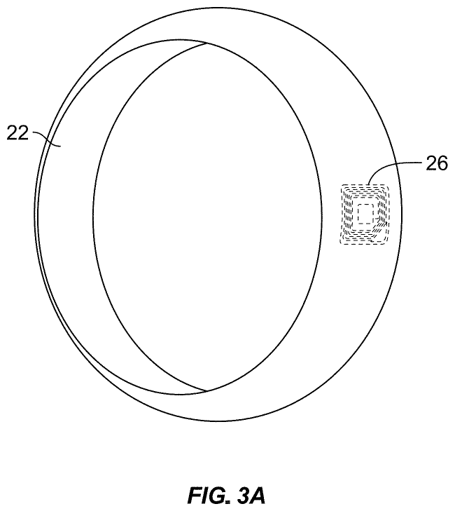

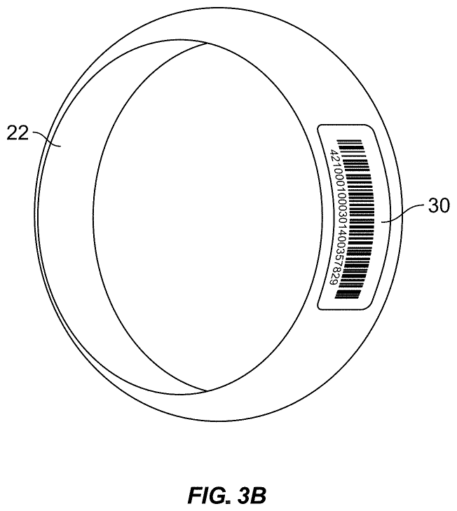

Furthermore, the heat shrunk plastic ring 22 can include a radio frequency identification (RFID) tag 26 as illustrated in FIG. 3A, allowing product information to be scanned and stored prior to installation. The RFID tag 26 may be used for illustration purposes and is not meant to limit to a certain type of RFID tags. It is contemplated that different types of RFID tags having different designs and frequency ranges can be used. The RFID tag 26 can have dimensions in the micrometers and be embedded within the heat shrunk plastic ring 22, as indicated by the dashed lines on the RFID tag 26. The RFID tag 26 can also be embedded on the heat shrunk plastic ring 22.

In addition, an Electronic Product Code (EPC) label 30 can be encoded on the RFID tag 26, wherein the EPC label 30 can be used to identify and track the female pipe fitting 10 or the sealing element 20 in the raised bead 16. In other embodiments, the RFID tag 26 can also be embedded in the EPC label 30. It is contemplated that the heat shrunk plastic ring 22 can also have a Universal Product Code (UPC). The RFID tag 26 can store information such as, but not limited to, a website link for installation instructions, suitability for service (e.g., aqueous or gas applications and the like), limitations of use, the type of sealing element, pressure suitability, temperature suitability, and the like. The RFID tag 26 can be used as a method to deliver information to the reader of the RFID tag 26 by sending the reader to the manufacturer's website or to a website location containing specific information about the fitting (e.g., female press fitting 10), including how it should be installed and maintained, temperature and pressure limitations, suitability for service, materials of construction, warranty information, and how to access additional information if required. Further, the crimping or press tool could have an RFID reader such that it can determine the location of the crimping/press tool relative to the RFID tag 26 to help the user ensure that such tool is in the appropriate position to preform the press/crimping.

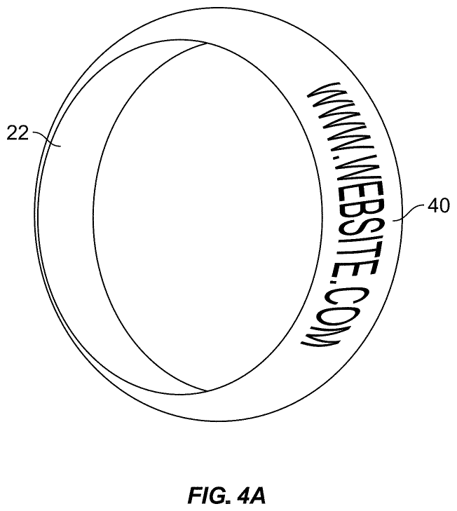

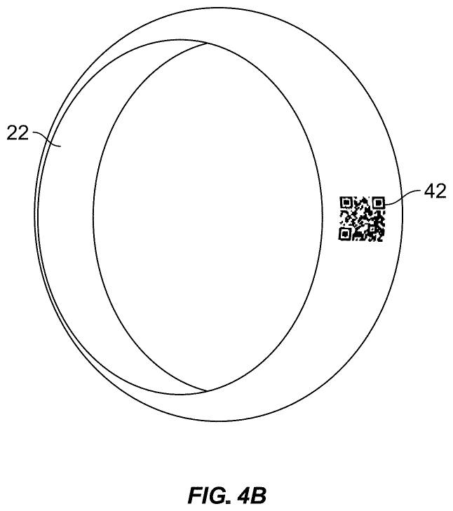

A website link 40 can also be printed on the heat shrunk plastic ring 22 as illustrated in FIG. 4A. In addition to or in place of the web site link 40, a Quick Response (QR) code 42 can also be printed on the heat shrunk plastic ring 22, wherein the QR code 42 can have dimensions as small as 1 cm (centimeter) by 1 cm. See FIG. 4B. The QR code 42 can provide the website link 40 and the website link 40 can provide installation instructions, information regarding the sealing element 20, and the like. The website link 40 and QR code 42 can be used as a method to deliver information similar to the RFID tag 26. For example, the website link 40 and QR code 42 can be used to send the reader of the website link 40 or QR code 42 to the manufacturer's website or to a website location containing specific information about the fitting (e.g., female press fitting 10), including how it should be installed and maintained, temperature and pressure limitations, suitability for service, materials of construction, warranty information, and how to access additional information if required.

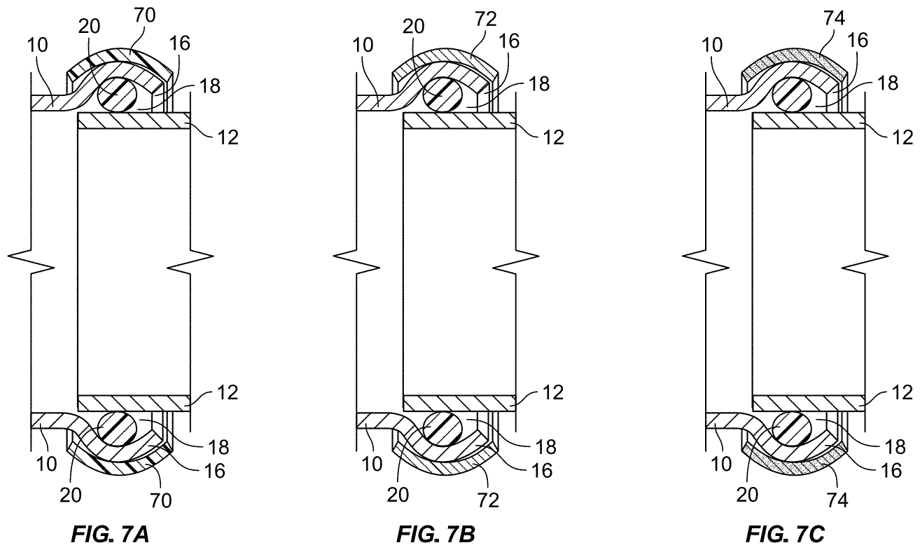

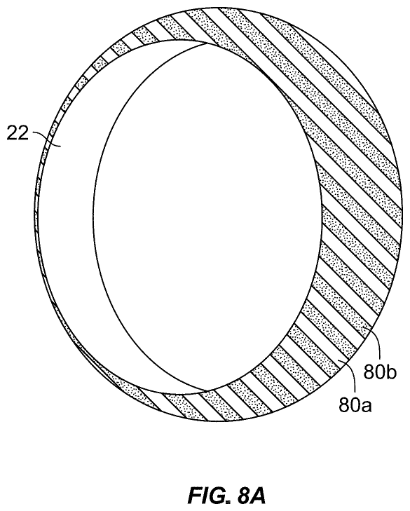

In other embodiments, instead of the visual indicator or VIPR being made of plastic or polyvinyl chloride (PVC), the VIPR can be made of metallic foil or paper material, making it easily recyclable. For example, FIGS. 7A-7C illustrate that the VIPR can be a plastic ring 70 similar to the heat shrunk plastic ring 22, metallic foil ring 72, or a paper material ring 74. While the PVC in the heat shrunk plastic ring 70 and the heat shrunk plastic ring 22 can be remelted and recycled, the likelihood of this happening is remote because the coloring and plasticizers added make it a niche material. Environmental concerns is increasingly getting attention and it is important on green projects such as builds that seek the Leadership in Energy and Environment Designs (LEED) certification.

It is contemplated that the metallic foil ring 72 and paper material ring 74, as well as the plastic ring 70, can be color coded, embedded with RFID tags, have perforated lines, designs, website links, EPC labels, UPC labels, QR codes, and other embodiments similar to the heat shrunk plastic ring 22. For the metallic foil ring 72, an RFID tag can be embedded on the metallic foil material if radio frequency signals would be hindered if the RFID tag is embedded within the metallic foil ring 72. An RFID tag can also be embedded within or on the paper material ring 74, as well as the plastic ring 70. The metallic foil ring 72 and the paper material ring 74 can be color coded with one or more colors, one or more photoluminescence colors, mechanophores, and be printed with information, logos, website links, EPC labels, UPC labels, QR codes, and the like, as described in embodiments for the heat shrunk plastic ring 22.

The metallic foil ring 72 and paper material ring 74, as well as the plastic ring 70, can be designed to break away similar to the heat shrunk plastic ring 22. For example, the metallic foil ring 72 and paper material ring 74 can be designed to break away at one or more places, such as at predefined locations. The metallic foil ring 72 and the paper material ring 74 can be provided with one or more perforated lines that will rupture and separate from the female press fitting 10. The perforated lines can extend transversely across the metallic foil ring 72 and paper material ring 74 in one or more areas to break at one or more locations, such as at predefined or predetermined locations.

The metallic foil ring 72 and paper material ring 74 can have varying thickness with one or more relatively thin areas particularly designed to rupture or break in response to a crimping action being applied to the metallic foil ring 72 or paper material ring 74. Alternatively, the metallic foil ring 72 and paper material ring 74 may be designed with a uniform thickness and a yield strength sufficiently low such that the metallic foil ring 72 or paper material ring 74 tears away from the raised bead 16 during a crimping action. In another example, the metallic foil ring 72 or paper material ring 74 is produced in strips held together with an adhesive and designed to break away into strips. The standard press tool (e.g., crimping tool 24) can deliver 7200 pounds of compression force. A thin paper, foil, or plastic such as the rings 70, 72, and 74 will break under significantly less force, regardless of how it is held together. Paper or foil would yield and break with significantly less force than a plastic ring of comparable thickness because they stretch much less before tearing apart. The rings 70, 72, and 74 break because they can no longer stretch under the pressure applied. Having perforated lines or areas designed to rupture can ensure that the breaks occur at one or more designated locations, especially if it is desired that a clean break occurs at one location on the rings 70, 72, or 74.

It should further be understood that the various features identified above may individually be included in each of the applicable pipes and/or heat shrunk plastic ring 22 (or rings 70, 72, or 74) or may be combined in any appropriate manner to be included in the pipes and/or heat shrunk plastic ring 22 (or rings 70, 72, or 74). The combination of the aforementioned features can result in a pipefitting that is easy to use, almost foolproof to operate and crimp appropriately and ensures that the appropriate pipes or used for the appropriate application and environment.

The present invention may, of course, be carried out in other specific ways than those herein set forth without departing from the scope and the essential characteristics of the invention. The present embodiments are therefore to be construed in all aspects as illustrative and not restrictive and all changes coming within the meaning and equivalency range of the appended claims are intended to be embraced therein.

What is claimed is:

1. A female press fitting designed to receive a male pipe or fitting and comprising:
a pipe section comprising at least two ends;
at least one raised bead forming an internal groove in the pipe section adjacent to one or more ends;
a sealing element disposed in the internal groove underneath the at least one raised bead; and
a heat shrunk plastic ring extending over and around the at least one raised bead and held on the pipe section, wherein
the heat shrunk plastic ring is color coded based on characteristics of the sealing element, wherein
the heat shrunk plastic ring is designed to break and separate from the pipe section in response to a crimping force being applied to the heat shrunk plastic ring and the at least one raised bead, and wherein
a presence of the heat shrunk plastic ring on the female press fitting that has received the male pipe or fitting indicates that the female press fitting has not been crimped or has been improperly crimped.

2. The female press fitting of claim 1 wherein the heat shrunk plastic ring is color coded with one or more photoluminescence colors or one or more colors that are not photoluminescence.

3. The female press fitting of claim 2 wherein the one or more photoluminescence colors or the one or more colors form different patterns, designs, words, or logos.

4. The female press fitting of claim 1 wherein the characteristics of the sealing element comprises type of sealing element, pressure suitability, or temperature suitability.

5. The female press fitting of claim 4 wherein the type of sealing element comprises of ethylene-propylene-diene monomer (EPDM), hydrogenated nitrile butadiene rubber (HNBR), fluoroelastomer (FKM), Teflon®, or Neoprene®.

6. The female press fitting of claim 1 wherein the heat shrunk plastic ring is embedded with mechanophores to indicate distribution and magnitude of pressure applied on the at least one raised bead by changing color.

7. The female press fitting of claim 1, wherein the heat shrunk plastic ring is embedded with a radio frequency identification (RFID) tag, and wherein the RFID tag stores information comprising of a website link for installation instructions, suitability for service, limitations of use, type of sealing element, pressure suitability, temperature suitability, warranty information, force required to properly crimp, or information on the female press fitting or the male pipe or fitting.

8. The female press fitting of claim 1, wherein a website link or Quick Response (QR) code containing the website link is printed on the heat shrunk plastic ring, and wherein the website link contains installation instructions, operating instructions, functional limitations, warranty information, manufacturer information, force required to properly crimp, operating limitations, or information on the female press fitting or the male pipe or fitting.

9. The female press fitting of claim 1 wherein the sealing element is driven inwardly into a sealing contact and engage with the male pipe or fitting in response to the crimping force being applied to the heat shrunk plastic ring.

10. The female press fitting of claim 1 wherein the heat shrunk plastic ring comprises one or more perforated lines designed to break at the one or more perforated lines and separate from the pipe section in response to the crimping force.

11. The female press fitting of claim 1 wherein the heat shrunk plastic ring vary in thickness and break at a relatively thin area.

12. The female press fitting of claim 1 wherein the heat shrunk plastic ring has a uniform thickness at a sufficiently low yield strength designed to break in response to the crimping force.

13. The female press fitting of claim 1 wherein the heat shrunk plastic ring comprises of strips held together with an adhesive and is designed to break into the strips.

14. The female press fitting of claim 1 wherein the heat shrunk plastic ring is designed to break at about 20% of the crimping force of approximately 7200 pounds.

15. A female press fitting designed to receive a male pipe or fitting and comprising:
a pipe section comprising at least two ends;
one or more raised beads forming one or more internal grooves in the pipe section adjacent to the at least two ends;
a sealing element disposed in the one or more internal grooves underneath the one or more raised beads; and
a paper material ring extending over and around the one or more raised beads and held on the pipe section, wherein the paper material ring is designed to break in response to a crimping force being applied to the paper material ring.

16. The female press fitting of claim 14, wherein a presence of the paper material ring on the female press fitting that has received the male pipe or fitting indicates that the female press fitting has not been crimped or has been improperly crimped.

17. The female press fitting of claim 14 wherein the sealing element comprises of ethylene-propylene-diene monomer (EPDM), hydrogenated nitrile butadiene rubber (HNBR), fluoroelastomer (FKM), Teflon®, or Neoprene®.

18. The female press fitting of claim 14, wherein the paper material ring is embedded with a radio frequency identification (RFID) tag, and wherein the RFID tag stores information comprising of a website link for installation instructions, suitability for service, limitations of use, type of sealing element, pressure suitability, temperature suitability, warranty information, force required to properly crimp, or information on the female press fitting or the male pipe or fitting.

19. The female press fitting of claim 14, wherein a website link or Quick Response (QR) code containing the website link is printed on the heat shrunk plastic ring, and wherein the website link contains installation instructions, operating instructions, functional limitations, warranty information, manufacturer information, force required to properly crimp, operating limitations, or information on the female press fitting or the male pipe or fitting.

20. A female press fitting comprising:
a pipe section;
one or more raised beads forming one or more grooves in the pipe section;
one or more metallic foil rings extending over and around the one or more raised beads and held on the pipe section; and
a sealing element disposed in the one or more grooves, wherein
the sealing element forming a sealing contact with a male pipe in response to a crimping force applied to the one more raised bead, and wherein
the one or more metallic foil rings are designed to break in response to a crimping force being applied to the one or more metallic foil rings to indicate that the female press fitting has been properly crimped.
